(19) United States
(12) Patent Application Publication
(10) Pub. No.: US 2015/0292944 A1
(43) Pub. Date: Oct. 15, 2015

(54) Fringe Reduction in Laser Spectroscopy

(71) Applicant: NEC Laboratories America, Inc., Princeton, NJ (US)

(72) Inventors: Yue Tian, Princeton, NJ (US); Ting Wang, West Windsor, NJ (US)

(21) Appl. No.: 14/682,363

(22) Filed: Apr. 9, 2015

Related U.S. Application Data
(60) Provisional application No. 61/978,069, filed on Apr. 10, 2014.
(60) Provisional application No. 61/978,044, filed on Apr. 10, 2014.

(51) Int. Cl. G01J 3/02; G01J 3/45

(52) U.S. Cl. CPC G01J 3/0297; G01J 3/45; G01J 3/0205

(57) ABSTRACT

An optical phase scrambler is coupled to a laser source to randomly modulate the optical phase. Since the optical phase is continuously changing in a random fashion, at the output of an etalon interferometer formed in the optical path, the two or more components in the interference always have certain time delay between each other, resulting in a random phase different between each other. Therefore, after interference, the fringe amplitude varies randomly as well. Then at the receiver side, the fringe noise is greatly reduced after averaging over time.

### RELATED APPLICATION INFORMATION

This application claims priority to provisional application No. 61/978,069, filed Apr. 10, 2014, entitled “Fringe reduction method in linear spectroscopy”, and claims priority to provisional application 61/978,044, entitled “Optical Fiber-Based Remote Gas Leakage Monitoring with Sensor Identifier”, filed Apr. 10, 2014, the contents thereof are incorporated herein by reference.

### BACKGROUND OF THE INVENTION

The present invention relates generally to optics, and more particularly, to fringe reduction in laser spectroscopy.

In laser spectroscopy for trace gas sensing, the effect of etalon fringes on laser spectra is a major noise source, which consists of periodic ripple in the transmitted laser power across the spectra. This fringe noise usually limits the sensitivity of a laser spectroscopy measurement of a trace gas concentration.

Minimization of interference fringe effects has been carried out by several approaches. Additional wavelength modulation methods such as two-tone modulation have been used to reduce the fringe amplitude. Such methods are only valid when the characteristic widths of the fringes are different from the absorption lines of the gas molecules. Another approach is to use piezoelectric transducers or motors to vibrate the fringe-forming elements, e.g. lenses. The fast changes of the fringe-forming condition, i.e. optical path length, constantly change the amplitude and period of the fringe patterns, which can be reduced by averaging over time. But the additional moving parts make the system more difficult to maintain and less robust to environmental changes. Yet another approach for minimizing interference fringe effects has been reported using a transmissive plate in the beam path approximately at Brewster's angle between the optical surfaces causing fringes. The transmissive plate is angularly oscillated to continuously vary the optical path length between the fringe-forming surfaces, so as to reduce the fringes on a time-averaged basis. Other than the drawback of the moving parts same as the previous approach, a major disadvantage of this approach is that an additional plate is inserted into the optical path which causes substantial displacement of the beam and increases the design complication especially for a multi-pass cell.

Accordingly, there is a need for an improved fringe reduction in laser spectroscopy.

### BRIEF SUMMARY OF THE INVENTION

The invention is directed to a method that includes placing an optical phase scrambler before optical fringe forming elements of an interferometer in a laser spectroscopy use, imposing continuously, by the phase scrambler, a random phase modulation onto a light beam directed to the fringe elements, detecting from light outputs of the fringe elements random optical phase difference; and averaging over time an electric signal representing a random optical phase difference of outputs from the fringe elements, the averaging enables reducing fast amplitude variation or fringe noise due to the interferometer.

In a similar aspect of the invention there is provided an apparatus that includes an optical phase scrambler for being coupled to a light source, the optical phase scrambler continuously randomly modulating the light source, an interferometer coupled to the optical phase scrambler with light outputs that have a random phase difference responsive to the random modulation by the phase scrambler, and a controller for converting light outputs from the interferometer to an electric signal and averaging the electric signal over time to enable reduction of fringe noise due to the interferometer.

In yet another similar aspect of the invention, there is provided, responsive to laser spectroscopy with an optical phase scrambler for being coupled to a light source, the optical phase scrambler continuously randomly modulating the light source; and with an interferometer coupled to the optical phase scrambler with light outputs that have a random phase difference responsive to the random modulation by the phase scrambler, a controller that includes detecting from light outputs of the fringe elements a random optical phase difference, and averaging over time an electric signal representing a random optical phase difference of outputs from the fringe elements, the averaging enables reducing fast amplitude variation or fringe noise due to the interferometer

These and other advantages of the invention will be apparent to those of ordinary skill in the art by reference to the following detailed description and the accompanying drawings.

### BRIEF DESCRIPTION OF THE DRAWINGS

FIG. 1 shows optical phase scrambling for fringe reduction in laser spectroscopy, in accordance with the invention.

FIG. 2 shows a controller with optical scrambling in a laser spectroscopy sensing of a medium.

FIG. 3 is a flow diagram of key aspects of laser spectroscopy in accordance with the invention.

FIG. 4 is a diagram of an exemplary computer or controller for implementing out the inventive fringe reduction in laser spectroscopy.

### DETAILED DESCRIPTION

The invention provides an optical phase scrambler that is placed next to a laser source to randomly modulate the optical phase. Since the optical phase is continuously changing in a random fashion, at the output of an etalon interferometer formed in the optical path, the two or more components in the interference always have certain time delay between each other, resulting in a random phase different between each other. Therefore, after interference, the fringe amplitude varies randomly as well. Then at the receiver side, the fringe noise is greatly reduced after it is averaged over time.

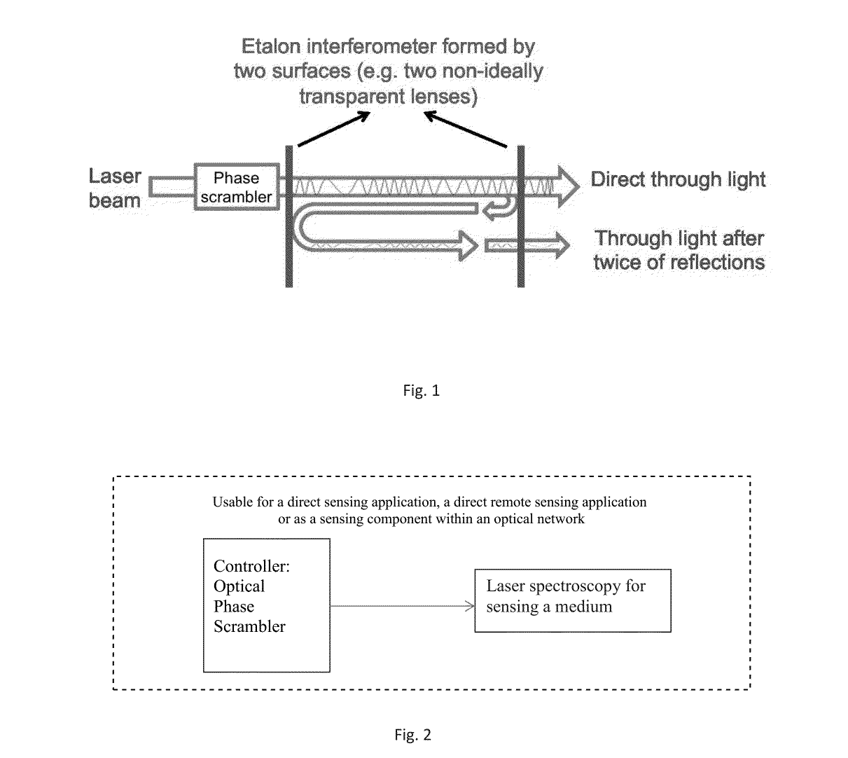

FIG. 1 shows application of the inventive fringe reduction in a laser spectroscopy situation.

A phase scrambler is placed between the laser beam light source and Etalon interferometer. The Etalon interferometer is formed by two surfaces, e.g., two non-ideally transparent lenses. The interferometer produces a direct light output and a light output after two reflections inside the Etalon interferometer.

Again, the phase scrambler is placed before the light path where etalons are possible to form, e.g. two non-ideally transparent lenses, multi-pass cells. The optical phase of the incident laser beam is continuously modulated by the phase scrambler in a random fashion. Therefore after the phase scrambler, the laser beam has a randomly changing phase. In an etalon, the direct through light beam interferes with the through light after twice (or more) of reflections in the etalon due to non-ideal transparency of the surface. Since the direct through light experiences different travel time in the etalon from other through light components, they have a random phase difference over time between each other. Then after interference, the optical phase is randomly changing over time as well. Therefore, the fringe noise due to the etalon can be greatly reduced by averaging the electric signal after detection over time.

FIG. 2 shows application of the phase scrambler in a laser spectroscopy application for sensing a medium such as a trace gas sensing.

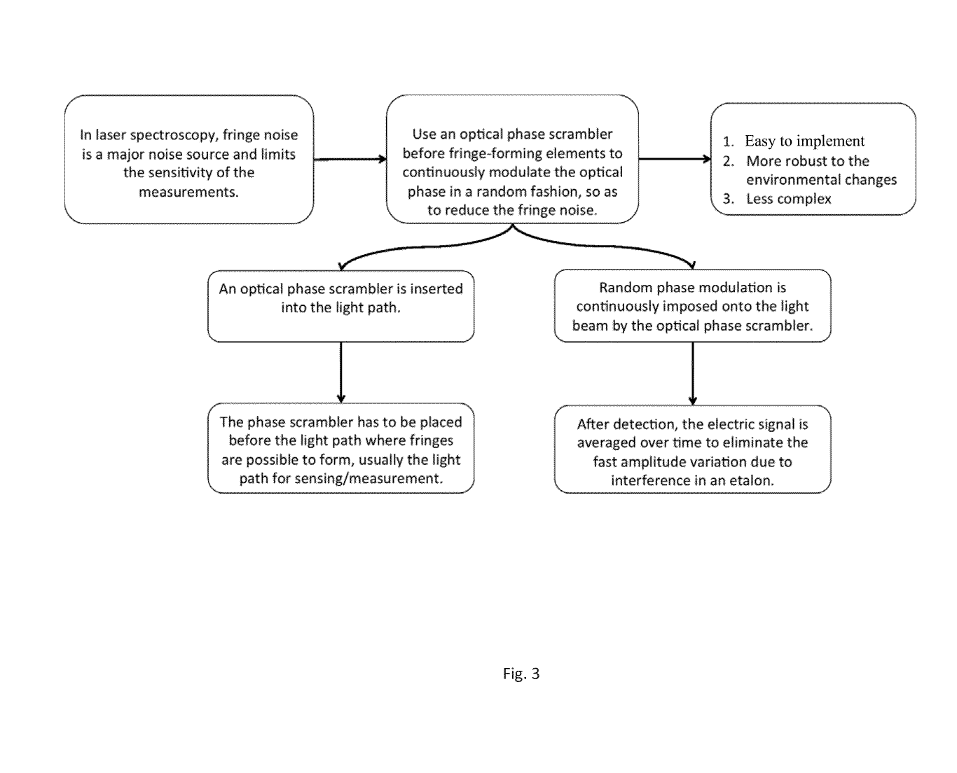

FIG. 3 shows key aspects of the invention fringe reduction in laser spectroscopy. As noted in laser spectroscopy, fringe noise is a major source and limits the sensitivity of the measurements. The inventive optical phase scrambling before fringe forming optical elements is used to continuously modulate the optical phase in a random fashion so as to reduce the fringe noise. The optical phase scrambler is inserted into the light path. The phase scrambler has to be placed before the light path where fringes are possible to form, usually in the light path for sensing or measurement. Random phase modulation is continuously imposed into the light beam by the phase scrambler. After detection, the electric signal is averaged over time to eliminate the fast amplitude variation due to interference in an etalon.

The invention may be implemented in optical components, controller/computer hardware, firmware or software, or a combination of the three. Preferably, data processing aspects of the invention is implemented in a computer program executed on a programmable computer or a controller having a processor, a data storage system, volatile and non-volatile memory and/or storage elements, at least one input device and at least one output device. More details are discussed in U.S. Pat. No. 8,380,557, the content of which is incorporated by reference.

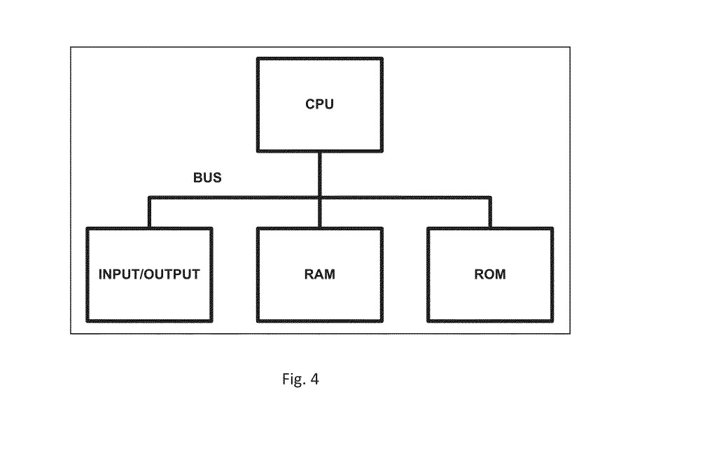

By way of example, a block diagram of a computer or controller to support the invention is discussed next in FIG. 4. The computer or controller preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

From the foregoing, it can be appreciated that the present invention greatly reduces the fringe noise in laser spectroscopy without adding additional moving parts or modifying the light path for measurements, which is easy to achieve, and more robust to the environmental changes and less complex than other approaches. In applications such as trace gas sensing where unwanted gas can be a significant risk to life an improvement in laser spectroscopy in such situations can save life or property.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method comprising:
placing an optical phase scrambler before optical fringe forming elements of an interferometer in a laser spectroscopy use;
imposing continuously, by the phase scrambler, a random phase modulation onto a light beam directed to the fringe elements;
detecting from light outputs of the fringe elements random optical phase difference; and
averaging over time an electric signal representing a random optical phase difference of outputs from the fringe elements, the averaging enables reducing fast amplitude variation or fringe noise due to the interferometer.

2. The method of claim 1, wherein the interferometer is of an Etalon type.

3. The method of claim 1, wherein the placing comprises placing the phase scrambler in a light path for sensing or measurement.

4. An apparatus comprising:
an optical phase scrambler for being coupled to a light source, the optical phase scrambler continuously randomly modulating the light source;
an interferometer coupled to the optical phase scrambler with light outputs that have a random phase difference responsive to the random modulation by the phase scrambler; and
a controller for converting light outputs from the interferometer to an electric signal and averaging the electric signal over time to enable reduction of fringe noise due to the interferometer.

5. The apparatus of claim 4, wherein the interferometer comprises an Etalon type.

6. The apparatus of claim 4, wherein the phase scrambler comprises being placed in a light path for sensing or measurement.

7. A controller comprising:
a controller responsive to laser spectroscopy with an optical phase scrambler for being coupled to a light source, the optical phase scrambler continuously randomly modulating the light source; and with an interferometer coupled to the optical phase scrambler with light outputs that have a random phase difference responsive to the random modulation by the phase scrambler, the controller comprising:
detecting from light outputs of the fringe elements a random optical phase difference; and
averaging over time an electric signal representing a random optical phase difference of outputs from the fringe elements, the averaging enables reducing fast amplitude variation or fringe noise due to the interferometer.
